(19) United States
(12) Patent Application Publication
(10) Pub. No.: US 2026/0348054 A1
(43) Pub. Date: Nov. 5, 2026

(54) TEXTILE SHREDDER DEVICE

(71) Applicant: Regents of the University of Minnesota, Minneapolis, MN (US)

(72) Inventors: Abigail CLARKE-SATHER, Minneapolis, MN (US); Paulo Henrique Teixeira Franca ALVES, Minneapolis, MN (US)

(21) Appl. No.: 19/483,647

(22) PCT Filed: May 17, 2024
(86) PCT No.: PCT/US2024/029930

§ 371 Date: Nov. 12, 2025

Related U.S. Application Data
(60) Provisional application No. 63/503,209, filed on May 19, 2023.

(51) Int. Cl. D01G 11/04; B02C 4/02; B02C 4/32

(52) U.S. Cl. CPC D01G 11/04; B02C 4/02; B02C 4/32

(57) ABSTRACT

A textile shredder device includes a shred station and a shred chamber. The shred station includes a first shred drum a second shred drum and at least one motor. The first shred drum is configured to rotate about a first axis and includes a cylindrical exterior surface having textile shredding teeth. The second shred drum is positioned alongside the first shred drum and is configured to rotate about a second axis, which is substantially parallel to the first axis. The second shred drum includes a cylindrical exterior surface having textile shredding teeth. The shred chamber contains the first and second shred drums and includes a recirculating tray extending along a bottom side of the first and second shred drums and alongside the second shred drum.

### FIELD

Embodiments of the present disclosure relate to a textile shredder device for shredding various textile wastes so as to obtain fibers which may be reused to make yarns and other materials.

### BACKGROUND

Textile shredding is a common mechanical process that deconstructs textile wastes, by shredding or cutting, into fibers that may be reused. Typically, this process is performed using very large industrial-sized garnetting or textile shredding machines. These machines are permanently positioned, take up a large space and are very expensive. As a result, such machines are not portable and cannot be used to bring the textile shredding operation to multiple locations, such as to perform on-site textile waste shredding operations for small businesses, for example.

### SUMMARY

Embodiments of the present disclosure generally relate to textile shredder devices for shredding various textile wastes so as to obtain fibers which may be reused to make yarns and other materials, and methods of operating the devices.

One example of the device includes a shred station and a shred chamber (108). The shred station includes a first shred drum, a second shred drum and at least one motor. The first shred drum is configured to rotate about a first axis and includes a cylindrical exterior surface having textile shredding teeth. The second shred drum is positioned alongside the first shred drum and is configured to rotate about a second axis, which is substantially parallel to the first axis. The second shred drum includes a cylindrical exterior surface having textile shredding teeth. The shred chamber contains the first and second shred drums and includes a recirculating tray extending along a bottom side of the first and second shred drums and alongside the second shred drum. When textile waste is fed into the shred chamber onto a top side of the first and second shred drums that is opposite the bottom side, rotation of the first and second shred drums shreds the textile waste and drives the shredded textile waste along the bottom side of the first and second shred drums and the recirculation tray to the top side of the first and second shred drums for re-shredding.

In some embodiments, the shred station includes a first shaft supporting the first shred drum for rotation about the first axis, and a second shaft supporting the second shred drum for rotation about the second axis. The relative position of the first and second shafts are adjustable to either increase or decrease a distance separating the first and second axes and a gap between the cylindrical exterior surfaces of the first and second shred drums.

The shred station may include a pair of first bearing brackets supporting the first shaft, wherein each first bearing bracket is adjustable to shift the first shaft toward or away from the second shaft, and/or a pair of second bearing brackets supporting the second shaft, wherein each second bearing bracket is adjustable to shift the second shaft toward or away from the first shaft.

The textile shredder device may also include at least one nozzle that is configured to direct at least one airflow produced by a source of compressed air into the shred chamber along the bottom side of the first and second shred drums and the recirculating tray.

The device may include a central plane extending perpendicular to the first and second axes and a center of the first and second shred drums, and the at least one nozzle includes a first nozzle located on a first side of the central plane and configured to direct a first airflow along and toward the central plane, and a second nozzle located on a second side of the central plane that is opposite the first side and configured to direct a second airflow along and toward the central plane.

The device may also include the source of compressed air, and at least one valve inline between the source of compressed air and the at least one nozzle.

The recirculating tray may include a door located on the bottom side of the first and second shred drums, the door having a closed position, in which the door forms a portion of a substantially continuous top surface of the recirculating tray that faces the bottom side of the first and second shred drums, and an open position, in which an opening is formed in the recirculating tray, through which the shredded textile waste may be discharged.

The device may include an actuator configured to move the door between the open and closed positions.

The device may include a ramp, a conveyor belt or a bin configured to receive the shredded waste material discharged through the opening in the recirculating tray when the door is in the open position.

In one embodiment of the method of operating a textile shredder device, the device includes a shred station including a first shred drum, a second shred drum and a at least one motor. The first shred drum is configured to rotate about a first axis and includes a cylindrical exterior surface having textile shredding teeth. The second shred drum is positioned alongside the first shred drum and is configured to rotate about a second axis, which is substantially parallel to the first axis. The second shred drum includes a cylindrical exterior surface having textile shredding teeth. The at least one motor is configured to drive rotation of the first and second shred drums about the corresponding first and second axes. The shred chamber contains the first and second shred drums and includes a recirculating tray that extends along a bottom side of the first and second shred drums and alongside the second shred drum. The method includes performing a shredding operation including rotating the first and second shred drums using the at least one motor, feeding textile waste into the shred chamber and onto a top side of the first and second shred drums that is opposite the bottom side, shredding the textile waste using the rotating first and second shred drums and discharging the shredded textile waste to the bottom side of the first and second shred drums and onto the recirculating tray. The method may also include re-shredding the shredded textile waste including driving the shredded textile waste along the recirculating tray to the top side of the first and second shred drums and re-shredding the shredded textile waste using the rotating first and second shred drums.

Driving the shredded textile waste may include driving the shredded textile waste along the recirculating tray to the top side of the first and second shred drums using at least one of the rotating first and second shred drums.

Rotating the first and second shred drums may comprise rotating the first and second shred drums in opposite directions.

The method may include performing a cleaning operation after the shredding operation including rotating the first and second shred drums in a second direction that is opposite the first direction.

The shred station may include at least one nozzle, and driving the shredded textile waste may include discharging at least one airflow through the at least one nozzle and into the shred chamber along the bottom side of the first and second shred drums and the recirculating tray, and driving the shredded textile waste along the recirculating tray to the top side of the first and second shred drums using the at least one airflow.

The textile shredder device may include a source of compressed air, at least one valve inline between the source of compressed air and the at least one nozzle, and a controller. The method may include discharging the at least one airflow by transitioning the valve from a closed position, in which the source of compressed air is disconnected from the at least one nozzle, to an open position using the controller, delivering pressurized air from the source of compressed air to the at least one nozzle through the open valve, and discharging the at least one airflow through the at least one nozzle using the pressurized air.

The textile shredder device may include a central plane that extends perpendicular to the first and second axes and a center of the first and second shred drums. The at least one nozzle may include a first nozzle located on a first side of the central plane, and a second nozzle located on a second side of the central plane that is opposite the first side. In the method, discharging the at least one airflow may include discharging a first airflow through the first nozzle along and toward the central plane, and discharging a second airflow through the second nozzle along and toward the central plane.

The recirculating tray may include a door located on the bottom side of the first and second shred drums, and the door may have a closed position, in which the door forms a portion of a substantially continuous top surface of the recirculating tray that faces the bottom side of the first and second shred drums, and an open position, in which an opening is formed in the recirculating tray, through which the shredded textile waste may be discharged. The device may include an actuator that is configured to move the door between the open and closed positions. In the method, performing the shredding operation may include using the actuator to move the door to the closed position.

The method may include performing a discharge operation after performing the shredding operation including moving the door from the closed position to the open position, wherein the shredded textile waste is discharged through the opening.

Another embodiment of the textile shredder device includes a shred station, a shred chamber and at least one nozzle. The shred station includes a first shred drum, a second shred drum and at least one motor. The first shred drum is configured to rotate about a first axis and includes a cylindrical exterior surface having textile shredding teeth. The second shred drum is positioned alongside the first shred drum and is configured to rotate about a second axis, which is substantially parallel to the first axis. The second shred drum includes a cylindrical exterior surface having textile shredding teeth. The at least one motor is configured to drive rotation of the first and second shred drums about the corresponding first and second axes. The shred chamber contains the first and second shred drums and includes a recirculating tray extending along a bottom side of the first and second shred drums and alongside the second shred drum. The recirculating tray includes a door having a closed position, in which the door forms a portion of a substantially continuous top surface of the recirculating tray that faces the bottom side of the first and second shred drums, and an open position, in which an opening is formed in the recirculating tray. The at least one nozzle is configured to direct at least one airflow produced by a source of compressed air into the shred chamber along the bottom side of the first and second shred drums and the recirculating tray.

In one embodiment, the shred station includes a first shaft supporting the first shred drum for rotation about the first axis, and a second shaft supporting the second shred drum for rotation about the second axis. A relative position of the first and second shafts is adjustable to either increase or decrease a distance separating the first and second axes and a gap between the cylindrical exterior surfaces of the first and second shred drums.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of a textile shredder device, in accordance with embodiments of the present disclosure.

FIGS. 2 and 3 respectively are simplified side and top views of the shred station and shred chamber, in accordance with embodiments of the present disclosure.

FIGS. 4 and 5 respectively are front and rear isometric views of an example of the textile shredder device, in accordance with embodiments of the present disclosure.

FIGS. 6-8 respectively are front, rear and top plan views of the example device, in accordance with embodiments of the present disclosure.

FIG. 9 is a cross-sectional view of the example device of FIG. 7 taken generally along line A-A.

FIG. 10 is a cross-sectional view of the example device of FIG. 7 taken generally along line B-B.

FIG. 11 is a cross-sectional view of the example device of FIG. 7 taken generally along line C-C.

FIG. 12 is a magnified cross-sectional view of the portion of the device of FIG. 11 within circle D.

FIGS. 13 and 14 are cross-sectional views of the example device of FIG. 8 taken generally along line E-E with a recirculation tray door in closed and open positions, respectively.

FIG. 15 is a simplified diagram of an example of a controller, in accordance with embodiments of the present disclosure.

FIG. 16 is a flowchart illustrating a method of operating a textile shredder device, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

Specific details are given in the following description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or may be shown in block diagram form in order to not obscure the embodiments in unnecessary detail.

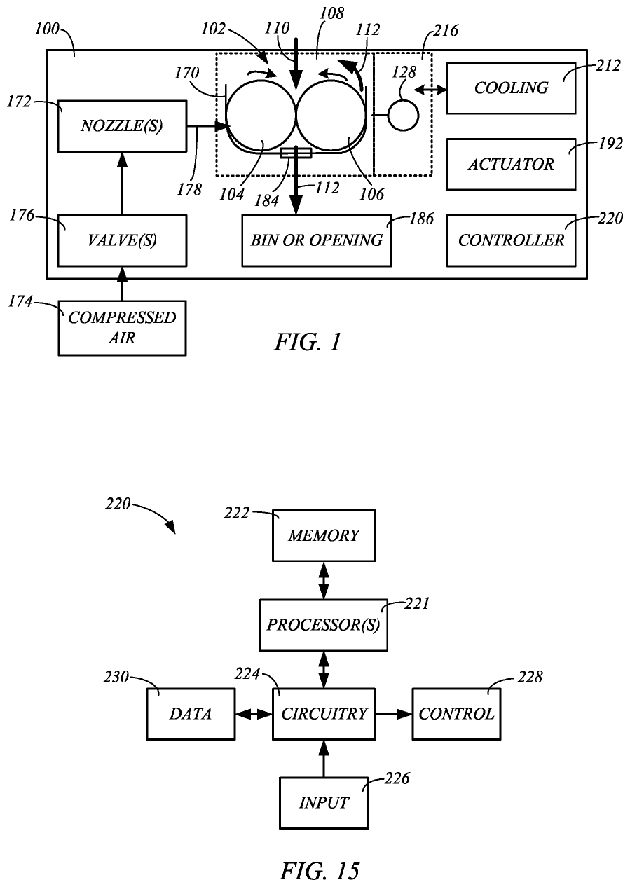

FIG. 1 is a simplified diagram of a textile shredder device 100, in accordance with embodiments of the present disclosure. The device 100 generally includes a shred station 102 that includes a pair of shred drums 104 and 106 that are contained within a shred chamber 108. The shred drums 104 and 106 may be driven by one or more motors 128 to perform a shred operation on textile wastes 110 within the chamber to form shredded textile waste 112 in the form of reusable fibers.

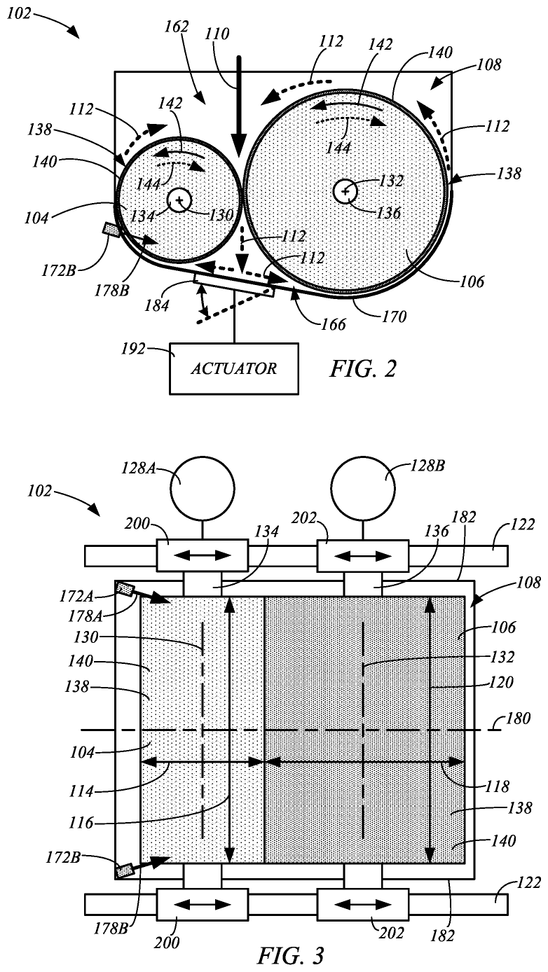

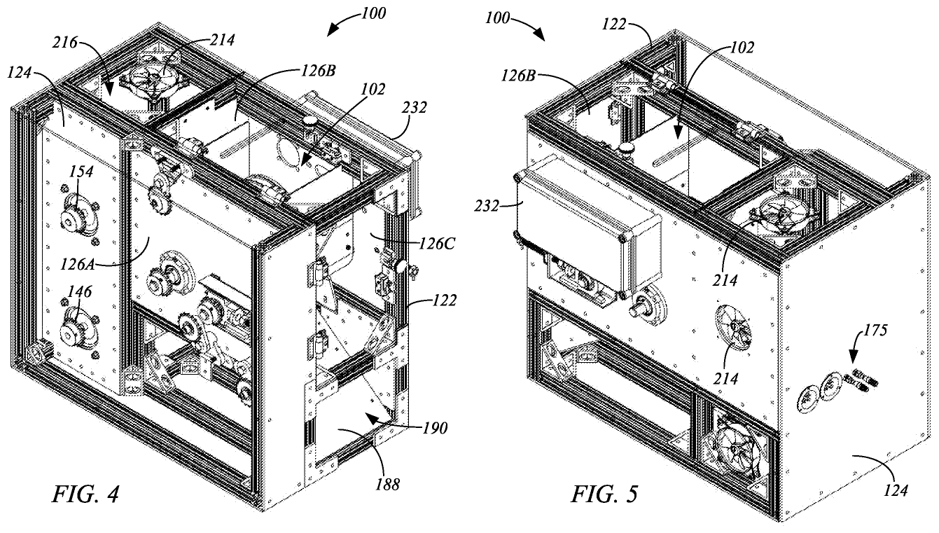

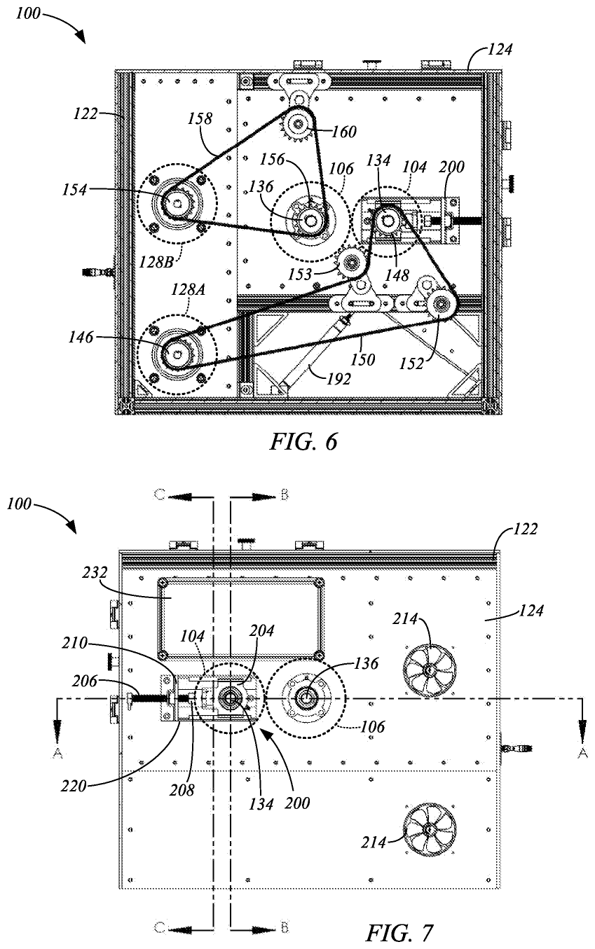

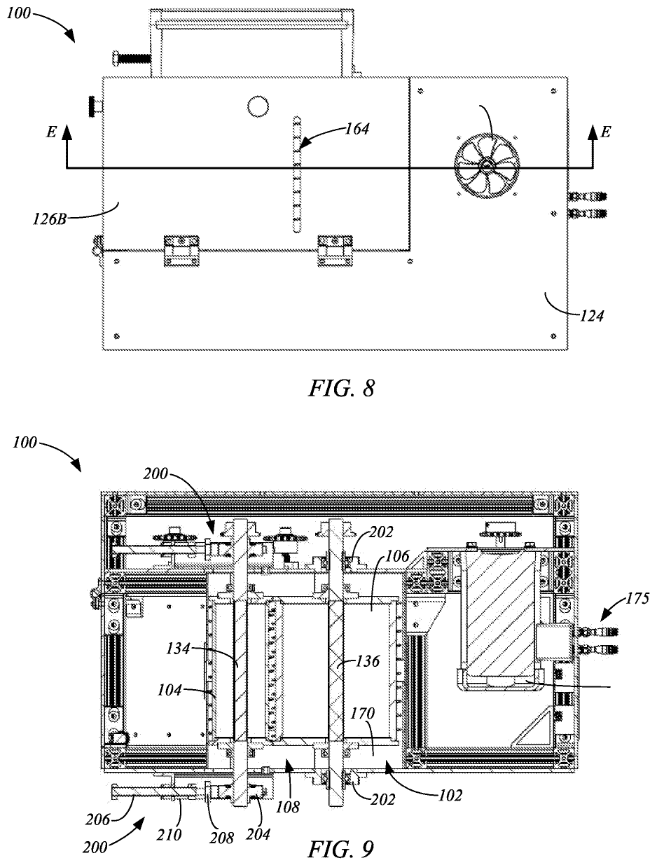

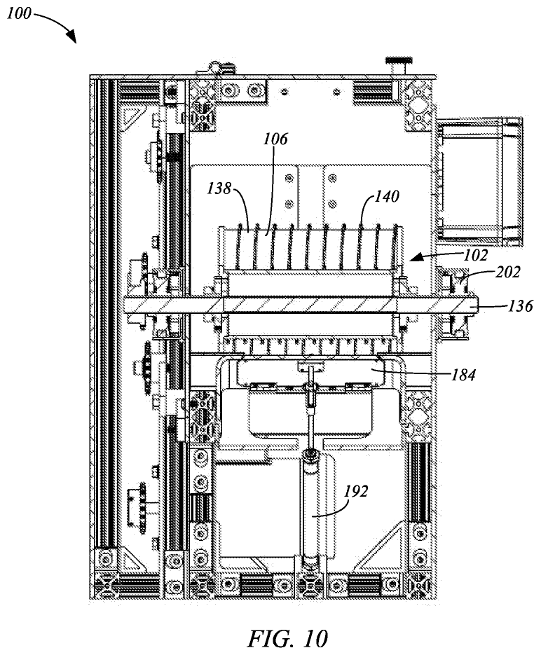

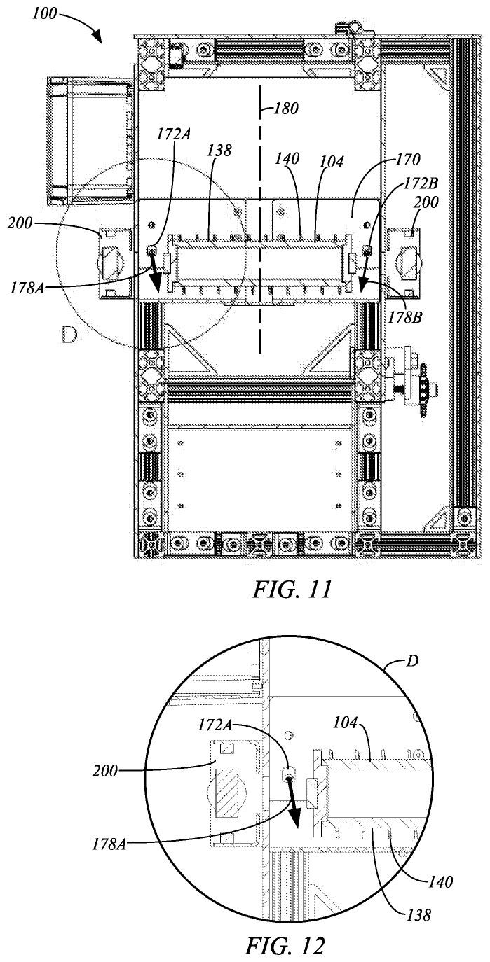

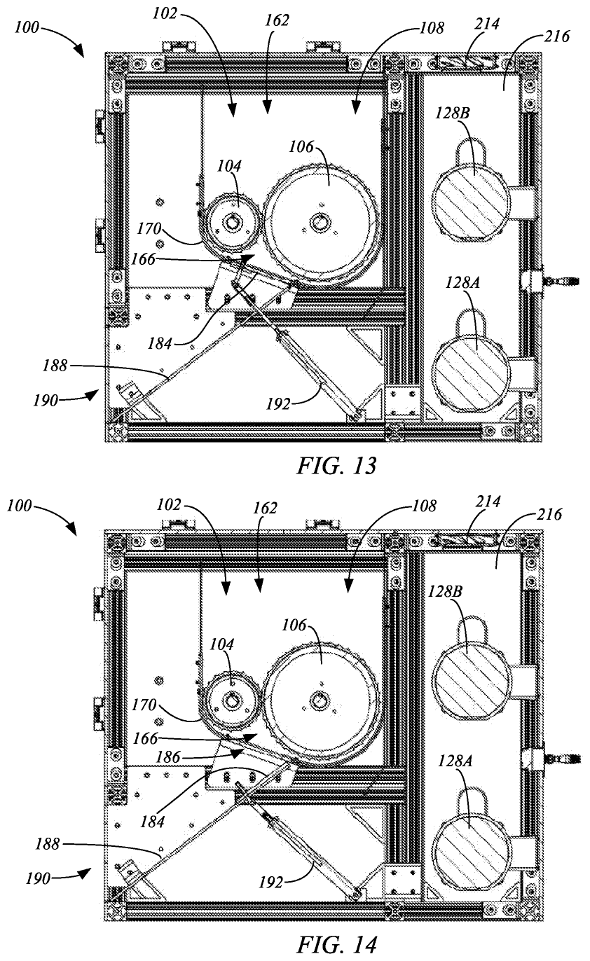

Features of the device 100 will also be described with reference to FIGS. 2-13. FIGS. 2 and 3 respectively are simplified side and top views of the shred station 102 and shred chamber 108, in accordance with embodiments of the present disclosure. FIGS. 4 and 5 respectively are front and rear isometric views of an example of the textile shredder device 100, in accordance with embodiments of the present disclosure. FIGS. 6-8 respectively are front, rear and top plan views of the example device 100, in accordance with embodiments of the present disclosure. FIG. 9 is a cross-sectional view of the example device 100 of FIG. 7 taken generally along line A-A. FIG. 10 is a cross-sectional view of the example device 100 of FIG. 7 taken generally along line B-B. FIG. 11 is a cross-sectional view of the example device 100 of FIG. 7 taken generally along line C-C. FIG. 12 is a magnified cross-sectional view of the portion of FIG. 11 within circle D. FIGS. 13 and 14 arc cross-sectional views of the example device 100 of FIG. 8 taken generally along line E-E with a recirculation tray door in closed and open positions, respectively.

The ability of the device 100 to perform such textile shredding operations using only the two shred drums 104 and 106 allows the device 100 to be formed much more compactly than conventional textile shredding devices or garnetting machines that are generally very large due to the use of numerous large shredding drums (e.g., twelve drums), are permanently positioned and are not mobile or transportable. In addition, the shred drums 104 and 106 may be much smaller than those used in conventional industrial textile shredder devices. In some embodiments, the shred drum 104 has a diameter 114 of approximately 3.0-6.0 inches, such as 4.5 inches, and a length 116 of approximately 10.5 inches, and the shred drum 106 has a diameter 118 of approximately 7.0-11.0 inches, such as 9.0 inches, and a length 120 of approximately 10.5 inches, as indicated in FIG. 3.

The compact nature of some embodiments of the device 100 make it reasonably transportable, such as by one or two people or using a small cart or forklift. This allows the device 100 to have the advantage of being configurable for transport to locations where textile waste shredding operations are needed.

In some embodiments, the device 100 includes a frame 122 (FIG. 4) for supporting various components, such as the shred drums 104 and 106. A housing 124 of the device 100 may comprise panels 126 that are attached to the frame 122 and enclose components of the device 100. In some embodiments, some of the panels, such as a front panel 126A, a top panel 126B and/or a side panel 126C, are clear panels that allow a user to view the shredding process and determine when the shredding operation is complete.

The shred drums 104 and 106 may be driven by one or more motors 128 to rotate about substantially parallel axes 130 and 132 (FIGS. 2 and 3), respectively. The drum 104 may be supported by a shaft 134 for rotation about the axis 130, and the drum 106 may be supported by a shaft 136 for rotation about the axis 132.

Each shred drum 104 and 106 includes a cylindrical exterior surface 138 having textile shredding teeth 140, which are represented by the shaded ring in FIG. 2, that operate to grip and shred the textile waste during a shredding operation. The textile shredding teeth may comprise tines, hooks or other suitable elements that are attached to the exterior surfaces of the drums 104 and 106, such as shown in FIG. 12. In one example, carding cloth containing the shredding teeth may be wrapped around the drums 104 and 106.

The one or more motors 128 operate to drive the shred drums 104 and 106 in a desired direction, and/or speed. Thus, as indicated in FIG. 2, the one or more motors 128 may drive the rotation of the shred drums 104 and 106 in the same direction, such as in a counter-clockwise direction 142 or in a clockwise direction 144, in opposing directions, and/or at different rotational speeds. These may be accomplished using a single motor 128 that drives rotation of both shred drums 104 and 106 through appropriate gear arrangements.

Alternatively, a motor 128A may be used to drive rotation of the shred drum 104 and a motor 128B may be used to drive the shred drum 106, as indicated in FIGS. 2, 6 and 13. The motor 128A may drive a gear 146, which in turn may drive a gear 148 connected to the shaft 134 of the shred drum 104 through a suitable link 150 (e.g., a chain or a belt), as shown in FIG. 6. The link 150 may be tensioned using a tensioning gear 152 and a tensioning gear 153. Likewise, the motor 128B may drive a gear 154, which in turn may drive a gear 156 connected to the axel 136 of the shred drum 106 through, for example, a suitable link 158 (e.g., a chain or a belt). The link 158 may be tensioned using a tensioning gear 160. Other arrangements may also be used to drive the drums 104 and 106.

In some embodiments, the device 100 is configured to perform a textile waste shredding operation by receiving textile waste 110 on a top side 162 of the shred drums 104 and 106. The textile waste 110 may be received through an opening in a top side of the housing, such as through an opening 164 (e.g., slot) in the top panel 126B of the housing 124 (FIG. 8), for example. The received textile waste 110 is then shredded by the rotating shred drums 104 and 106 to produce shredded textile waste 112 (dashed arrows), which is output on a bottom side 166 of the shred drums 104 and 106, as indicated in FIG. 2. In one example, the shred drums 104 and 106 are rotated in opposite directions to promote shredding of the textile waste 110. For example, the shred drum 104 may be rotated in the clockwise direction 144 while the shred drum 106 is rotated in the counter-clockwise direction 142. This may maximize shear between the shred drums 104 and 106 and the shredding of the textile waste 110. Alternatively, the shred drums could be rotated in the same direction (e.g., counter-clockwise direction 142) such that the exterior surface 138 of the shred drum 104 has a different angular speed than the exterior surface 138 of the shred drum 106.

The shredded textile waste 112 is then recirculated back to the top side 162, where it is shredded again by the drums 104 and 106. This process is repeated a limited number of times, such as until the expiration of a predetermined period of time, or until an operator of the device 100 stops the process.

In some embodiments, the shred chamber 108 includes a recirculation tray 170 (thick line in FIG. 2) that extends along the bottom side 166 of the drums 104 and 106 and alongside the shred drums 104 and 106 and facilitates the recirculation of the shredded textile waste 112 to the top side 162. For example, the rotation of the shred drum 104 in the direction 144 drives the shredded textile waste 112 on the bottom side 166 between the tray 170 and the shred drum 104 to the top side 162, and the rotation of the shred drum 106 in the direction 142 drives the shredded textile waste 112 on the bottom side 166 between tray 170 and the shred drum 104 to the top side 162, as indicated in FIG. 2. The shredding operation then continues by shredding the recirculated shredded textile waste 112 again between the drums 104 and 106 and recirculating the textile waste 112 back to the top side 162.

In some embodiments, the device 100 includes one or more nozzles 172, as indicated in FIG. 1. The nozzles 172 are configured to be connected to a source of compressed air 174, such as through ports 175 in the housing 124 (FIG. 5) and one or more valves (e.g., solenoid valves) 176 (FIG. 1). The source of compressed air 174 may take the form of a tank of compressed air or a compressor, for example, that is located within the device housing 124 or external to the device 100. The valves 176 may be manually or electronically controlled to discharge desired airflows 178 and airflow patterns into the shred chamber 108 through the one or more nozzles 172.

In some embodiments, the one or more nozzles 172 direct one or more airflows 178 along the recirculating tray 170 on the bottom side 166 to assist in driving the shredded textile waste 112 along the tray 170 and back to the top side 162 of the shred drums 104 and 106, as indicated in FIG. 2. In one example, the device includes nozzles 172A and 172B, as shown in FIGS. 3 and 11. The nozzles 172 may be positioned on opposing sides of a central plane 180, which extends perpendicular to the axes 130 and 132 and through a center of the shred drums 104 and 106. The nozzles 172A and 172B may be positioned at outer sides of the recirculating tray 170 and the shred drum 104 and angled toward the central plane 180. The nozzles 172A and 172B may direct the airflows 178A and 178B generally along the central plane 180 and/or toward the central plane 180. In one example, the nozzles 172 may extend through the recirculation tray 170 adjacent to the shred drum 104, as indicated in FIGS. 3, 11 and 12.

The airflows 178 discharged from the nozzles 172 direct the textile wastes 112 that are alongside sidewalls 182 (FIG. 3) of the shred chamber 108 back toward the central plane 180 and along the recirculation tray 170 to the top side where they can be further shredded by the shred drums 104 and 106. Accordingly, the nozzles 172 assist in preventing the shredded textile waste 112 from getting trapped between the sidewalls 182 and the drums 104 and 106 where they may avoid additional shredding by the drums 104 and 106.

Each airflow 178 may take on various forms through the control of the valve(s) 176. In one embodiment, each airflow 178 may be a continuous flow or a series of air pulses that are generated through the actuation of the one or more valves 176. The volumetric flow rate of each airflow 178 depends on the pressure of the compressed air source 174. In one example, the air pressure of the source 174 is approximately 90 psi, and the volumetric flow rate of each airflow 178 is approximately 0.001227 m³/second or 2.6 standard cubic feet per minute.

Embodiments of the airflows 178 discharged through the nozzles 172 include patterns that are the same or different, including simultaneous airflow patterns and/or alternating airflow patterns. Accordingly, the valves 176 may include separate valves for controlling the connection between the nozzles 172A and 172B and the source of compressed air 174.

In some embodiments, the recirculating tray 170 includes a door 184 on the bottom side 166 of the shred drums 104 and 106, as shown in FIGS. 1, 2, 13 and 14. The door 184 is placed in a closed position (FIGS. 2 and 13), in which it forms a portion of a continuous top surface of the recirculating tray 170, during shredding operations to facilitate the recirculation of the textile waste 112. After the shredding operation is completed, the door 184 may be transitioned to an open position, as indicated by the dashed line in FIG. 2 and shown in FIG. 14, to form an opening 186 in the tray 170, through which the shredded textile waste 112 may be discharged from the shred chamber 108, such as to a collection bin 186 (FIG. 1), or onto a ramp or conveyor belt 188 (FIG. 14) that may direct the shredded textile waste 112 through an opening 190 in the housing 124 for collection or further processing, for example.

The device 100 may include an actuator 192 that is configured to move the door 184 between the open and closed positions, as indicated in FIGS. 1 and 2. The actuator 192 may take on any suitable form, such as a pneumatic actuator 192 (FIGS. 13 and 14) that operates using the compressed air source 174, a motorized actuator, or another suitable actuator.

In some embodiments, the device 100 is configured to perform a cleaning and discharge operation following the shredding operation. This may involve, driving both of the shred drums 104 and 106 in the reverse of the direction they are rotated in during the shredding operation, at different speeds, or in another suitable manner to remove the shredded textile waste 112 from the shred drums 104 and 106, and possibly assist in driving the shredded textile waste 112 through the opening 186 when door 184 is opened. In one embodiment, the shred drum 104 may be rotated in the counter-clockwise direction 142 while the shred drum 106 is rotated in the clockwise direction 144 In some embodiments, the nozzles 172 discharge the airflows 178 to further assist in driving the shredded textile waste 112 off the drums 104 and 106 and walls 182 of the shred chamber 108 and through the opening 186.

In some embodiments, a gap between the drums 104 and 106 of the shred station 102 may be adjusted to allow the device 100 to accommodate different textile waste thicknesses. The device 100 may include a pair of bearing brackets 200 that are attached to the frame 122 and support the shaft 134 of the shred drum 104 for rotation about the axis 130, and a pair of bearing brackets 202 that are attached to the frame 122 and support the shaft 136 of the shred drum 106 for rotation about the axis 132, as shown in FIG. 3. The bearing brackets 200 and/or the bearing brackets 202 may be adjustable to shift the supported shafts 134 and 136 along the central plane to adjust the gap between the shred drums 104 and 106. Thus, for example, the bearing brackets 200 may be configured to adjust the position of the shaft 134 along the central plane 180, while the bearing brackets 202 may support the shaft 136 in a fixed position along the central plane 180.

An example of an adjustable form of the bearing bracket 200 is shown in FIG. 7. The bearing bracket 200 includes a bearing 204 that holds the shaft 134 supporting the shred drum for rotation about the axis 130 and a threaded rod 206 having an end 208. The threaded rod 206 is in threaded engagement with a member 210. The bearing 204 is configured to slide within the member 210. The rod 206 may be screwed in one direction to drive the end 208 toward the drum 106 along the central plane 180 and move the bearing 204 and the shaft 134 toward the shred drum 106, to thereby reduce the gap between the shred drums 104 and 106. Also, the rod 206 may be screwed in the opposite direction to drive the end 208 away from the drum 106 and move the bearing 204 and the shaft 134 along the central plane 180 away from the drum 106, to thereby increase the gap between the shred drums 104 and 106.

In some embodiments, the device 100 includes a cooling system 212 comprising one or more motorized fans 214 (FIG. 5) that operate to circulate air through portions of the interior of the housing 124, such as through a chamber 216 (FIG. 13) containing the motors 128A and 128B, for example. The fans 214 may be configured to pull exterior air into the housing 124 and/or expel air from within the housing 124 to the exterior.

The device includes at least one controller 220 (FIG. 1), for controlling one or more functions described herein. For example, the controller 220 may be used to control the motors 128, the valves 176, the actuator 192, the fans 214, and/or other components of the device 100 to perform various operations and functions described herein. Thus, the controller 220 may represent one or more motor distinct controllers (e.g., variable frequency drives), pneumatic controllers for controlling the valves and or the pneumatic actuator, and other controllers of the device 100.

FIG. 15 is a simplified diagram of an example of a controller 220, in accordance with embodiments of the present disclosure. The controller 220 may include one or more processors 221 and memory 222. The one or more processors 221 are configured to perform various functions described herein to facilitate the performance of one or more operations or functions (e.g., textile shredding operation, cleaning operation, textile discharge operation, etc.) described herein, such as in response to the execution of program instructions stored in the memory 222. The controller 220 may include circuitry 224 for use by the one or more processors 221 to receive input signals 226 (e.g., signals from a control panel), issue control signals 228 (e.g., signals that control the motors, the valves, the fans, etc.) and/or communicate data 230.

The one or more processors 221 may be components of one or more computer-based systems, and may include one or more control circuits, microprocessor-based engine control systems, and/or one or more programmable hardware components, such as a field programmable gate array (FPGA). The memory 222 represents local and/or remote memory or computer readable media. Such memory 222 comprises any suitable patent subject matter eligible computer readable media and does not include transitory waves or signals. Examples of the memory 222 include conventional data storage devices, such as hard disks, CD-ROMs, optical storage devices, magnetic storage devices and/or other suitable data storage devices.

In some embodiments, the device 100 includes an electronics box 232 (FIG. 5) that is removably attached to the housing 124 and includes electronics for the device 100, such as the one or more controllers 220 or portions thereof. A suitable plug may be used to connect the electronics within the box 232 to components of the device 100 (e.g., motors, fans, actuator, valves, etc.) that are internal to the housing 124. The ability to detach the electronics box 232 from the housing 124 simplifies servicing and replacement of the electronics and allows the size of the device 100 to be reduced, such as to simplify transport of the device 100.

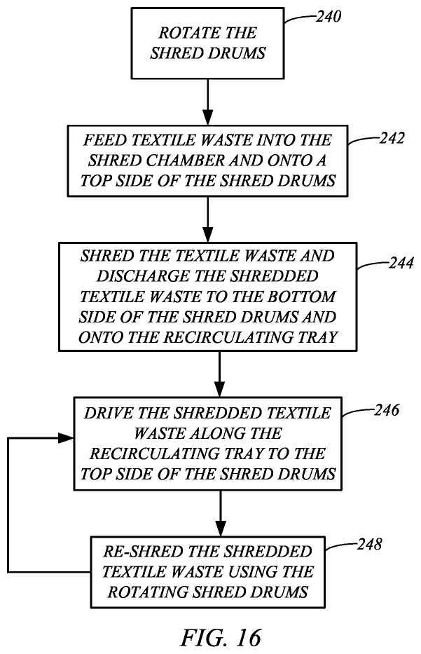

Additional embodiments of the present disclosure relate to a method of operating the device 100, which may be formed in accordance with one or more embodiments described herein. FIG. 16 is a flowchart illustrating an example of the method, in accordance with embodiments of the present disclosure.

At 240 of the method, the shred drums 104 and 106 are rotated about their axes 130 and 132 using the one or more motors 128 and textile waste 110 is fed into the shred chamber 108 and onto the stop side 162 of the shred drums 104 and 106, at 242, as discussed above with reference to FIG. 2. For example, the shred drum 104 may be rotated in the clockwise direction 144 while the shred drum 106 is rotated in the counter-clockwise direction 142. At 244 of the method, the textile waste 110 is shredded between the shred drums 104 and 106 in response to the rotating shred drums 104 and 106, and the shredded textile waste 112 is discharged to the bottom side 166 and onto the recirculating tray 170. Next, the shredded textile waste 112 is re-shredded by driving the shredded textile waste 112 along the recirculating tray 170 back to the top side 162 at 246. For example, the shredded textile waste 112 may be driven from the bottom side 166 between the shred drum 104 and the tray 170 to the top side 162 by the rotating shred drum 104, and the shredded textile waste 112 may be driven from the bottom side 166 between the shred drum 106 and the tray 170 to the top side 162 by the rotating shred drum 106, as shown in FIG. 2. At 248, the shredded textile waste 112 is re-shredded using the rotating first and second shred drums 104 and 106, as shown in FIG. 2.

This recirculation of the shredded textile waste 112 to the top side 162 may be facilitated through the rotation of the shred drums 104 and 106 and/or the one or more airflows 178 discharged by the one or more nozzles 172, as discussed above with reference to FIGS. 2 and 3. For example, the controller 220 may transition the one or more valves 176 from closed positions, in which no airflows are generated, to open positions, in which the pressurized air of the source 174 is connected to the nozzles 172, thereby generating the airflows 178.

The re-shredding operation may be repeated a limited number of times. For example, the controller 220 may continue the shredding operation for a predetermined period of time, or an operator of the device 100 may control the duration of the shredding operation.

Cleaning and/or discharging operations may follow the shredding operation to remove the shredded textile waste 112 from the shred drums 104 and 106 and discharge the shredded textile waste 112 from the shred chamber 108, such as through the open door 184. For example, the controller 220 may control the motors 128A and 128B to rotate each of the shred drums 104 and 106 in a desired direction (e.g., counter-clockwise direction 142 or clockwise direction 144) and at a desired speed that facilitates removal of the shredded textile waste 112 from the drums 104 and 106. In one embodiment, the shred drums 104 and 106 are rotated in the opposite direction that they were rotated in during the shredding operation. Additionally, the controller 220 may automatically transition the door 184 from the closed position to the open position using the actuator 192 to discharge the shredded textile waste 112 from the shred chamber 108.

Although the embodiments of the present disclosure have been described with reference to preferred embodiments, workers skilled in the art will recognize that changes may be made in form and detail without departing from the spirit and scope of the present disclosure.

As used herein, when one or more functions or process steps are described as being performed by a controller (e.g., a specific controller), one or more controllers, at least one controller, a processor (e.g., such as a specific processor), one or more processors or at least one processor, embodiments include the performance of the function(s) by a single controller or processor, or multiple controllers or processors, unless otherwise specified. Furthermore, as used herein, when multiple functions are performed by at least one controller or processor, all of the functions may be performed by a single controller or processor, or some functions may be performed by one controller or one processor, and other functions may be performed by another controller or processor. Thus, the performance of one or more functions by at least one controller or processor does not require that all of the functions are performed by each of the controllers or processors.

1. A textile shredder device for shredding textile waste comprising:
a shred station including:
a first shred drum configured to rotate about a first axis and comprising a cylindrical exterior surface having textile shredding teeth;
a second shred drum positioned alongside the first shred drum and configured to rotate about a second axis, which is substantially parallel to the first axis, and comprising a cylindrical exterior surface having textile shredding teeth; and
at least one motor configured to drive rotation of the first and second shred drums; and
a shred chamber containing the first and second shred drums and including a recirculating tray extending along a bottom side of the first and second shred drums and alongside the second shred drum,
wherein, when textile waste is fed into the shred chamber onto a top side of the first and second shred drums that is opposite the bottom side, rotation of the first and second shred drums shreds the textile waste and drives the shredded textile waste along the bottom side of the first and second shred drums and the recirculation tray to the top side of the first and second shred drums for re-shredding.

2. The device according to claim 1, wherein the shred station includes:
a first shaft supporting the first shred drum for rotation about the first axis; and
a second shaft supporting the second shred drum for rotation about the second axis,
wherein a relative position of the first and second shafts is adjustable to either increase or decrease a distance separating the first and second axes and a gap between the cylindrical exterior surfaces of the first and second shred drums.

3. The device according to claim 2, wherein the shred station includes:
a pair of first bearing brackets supporting the first shaft, wherein each first bearing bracket is adjustable to shift the first shaft toward or away from the second shaft; and/or
a pair of second bearing brackets supporting the second shaft, wherein each second bearing bracket is adjustable to shift the second shaft toward or away from the first shaft.

4. The device according to claim 1, including at least one nozzle configured to direct at least one airflow produced by a source of compressed air into the shred chamber along the bottom side of the first and second shred drums and the recirculating tray.

5. The device according to claim 4, wherein:
the device includes a central plane extending perpendicular to the first and second axes and a center of the first and second shred drums; and
the at least one nozzle includes:
a first nozzle located on a first side of the central plane and configured to direct a first airflow along and toward the central plane; and
a second nozzle located on a second side of the central plane that is opposite the first side and configured to direct a second airflow along and toward the central plane.

6. The device according to claim 4, including:
the source of compressed air; and
at least one valve in line between the source of compressed air and the at least one nozzle.

7. The device according to claim 4, wherein the recirculating tray includes a door located on the bottom side of the first and second shred drums, the door having a closed position, in which the door forms a portion of a substantially continuous top surface of the recirculating tray that faces the bottom side of the first and second shred drums, and an open position, in which an opening is formed in the recirculating tray, through which the shredded textile waste may be discharged.

8. The device according to claim 7, including an actuator configured to move the door between the open and closed positions.

9. The device according to claim 8, including a ramp or a bin configured to receive the shredded waste material discharged through the opening in the recirculating tray when the door is in the open position.

10. A method of operating a textile shredder device for shredding textile waste the textile shredder device comprising:
a shred station including:
a first shred drum configured to rotate about a first axis and comprising a cylindrical exterior surface having textile shredding teeth;
a second shred drum positioned alongside the first shred drum and configured to rotate about a second axis, which is substantially parallel to the first axis, and comprising a cylindrical exterior surface having textile shredding teeth; and
at least one motor configured to drive rotation of the first and second shred drums; and
a shred chamber containing the first and second shred drums and including a recirculating tray extending along a bottom side of the first and second shred drums and alongside the second shred drum,
the method including performing a shredding operation comprising:
rotating the first and second shred drums using the at least one motor;
feeding textile waste into the shred chamber and onto a top side of the first and second shred drums that is opposite the bottom side;
shredding the textile waste using the rotating first and second shred drums and discharging the shredded textile waste to the bottom side of the first and second shred drums and onto the recirculating tray; and
re-shredding the shredded textile waste including:
driving the shredded textile waste along the recirculating tray to the top side of the first and second shred drums; and
re-shredding the shredded textile waste using the rotating first and second shred drums.

11. The method according to claim 10, wherein driving the shredded textile waste includes driving the shredded textile waste along the recirculating tray to the top side of the first and second shred drums using at least one of the rotating first and second shred drums.

12. The method according to claim 10, wherein rotating the first and second shred drums comprises rotating the first shred drum in a first direction and rotating the second shred drum in in a second direction that is opposite the first direction.

13. The method according to claim 12, wherein the method includes performing a cleaning operation after the shredding operation comprising rotating the first shred drum in the second direction and rotating the second shred drum in the first direction.

14. The method according to claim 11, wherein:
the shred station includes at least one nozzle; and
driving the shredded textile waste includes:
discharging at least one airflow through the at least one nozzle and into the shred chamber along the bottom side of the first and second shred drums and the recirculating tray; and
driving the shredded textile waste along the recirculating tray to the top side of the first and second shred drums using the at least one airflow.

15. The method according to claim 14, wherein:
the textile shredder device includes:
a source of compressed air;
at least one valve inline between the source of compressed air and the at least one nozzle; and
a controller; and
discharging the at least one airflow includes:
transitioning the at least one valve from a closed position, in which the source of compressed air is disconnected from the at least one nozzle, to an open position using the controller;
delivering pressurized air from the source of compressed air to the at least one nozzle through the open valve; and
discharging the at least one airflow through the at least one nozzle using the pressurized air.

16. The method according to claim 15, wherein:
the textile shredder device includes a central plane extending perpendicular to the first and second axes and a center of the first and second shred drums;
the at least one nozzle includes:
a first nozzle located on a first side of the central plane; and
a second nozzle located on a second side of the central plane that is opposite the first side;
discharging the at least one airflow comprises:
discharging a first airflow through the first nozzle along and toward the central plane; and
discharging a second airflow through the second nozzle along and toward the central plane.

17. The method according to claim 10, wherein:
the recirculating tray includes a door located on the bottom side of the first and second shred drums, the door having a closed position, in which the door forms a portion of a substantially continuous top surface of the recirculating tray that faces the bottom side of the first and second shred drums, and an open position, in which an opening is formed in the recirculating tray, through which the shredded textile waste may be discharged; and
an actuator configured to move the door between the open and closed positions; and
performing the shredding operation includes using the actuator to move the door to the closed position.

18. The method according to claim 17, wherein the method includes performing a discharge operation after performing the shredding operation comprising moving the door from the closed position to the open position, wherein the shredded textile waste is discharged through the opening.

19. A textile shredder device for shredding textile waste comprising:
a shred station including:
a first shred drum configured to rotate about a first axis and comprising a cylindrical exterior surface having textile shredding teeth;
a second shred drum positioned alongside the first shred drum and configured to rotate about a second axis, which is substantially parallel to the first axis, and comprising a cylindrical exterior surface having textile shredding teeth and
at least one motor configured to drive rotation of the first and second shred drums;
a shred chamber containing the first and second shred drums and including a recirculating tray extending along a bottom side of the first and second shred drums and alongside the second shred drum, the recirculating tray including a door having a closed position, in which the door forms a portion of a substantially continuous top surface of the recirculating tray that faces the bottom side of the first and second shred drums, and an open position, in which an opening is formed in the recirculating tray; and
at least one nozzle configured to direct at least one airflow produced by a source of compressed air into the shred chamber along the bottom side of the first and second shred drums and the recirculating tray.

20. The device according to claim 19, wherein the shred station includes:
a first shaft supporting the first shred drum for rotation about the first axis; and
a second shaft supporting the second shred drum for rotation about the second axis,
wherein a relative position of the first and second shafts is adjustable to either increase or decrease a distance separating the first and second axes and a gap between the cylindrical exterior surfaces of the first and second shred drums.
